(19) United States
(12) Patent Application Publication
(10) Pub. No.: US 2005/0034610 A1
(43) Pub. Date: Feb. 17, 2005

(54) Method and apparatus for the superficial conditioning food extrusions

(76) Inventors: Giovanni Battista Righele, Zane' VI (IT); Michaelo Melnyczuk, Stellenbosch (ZA)

Correspondence Address: Leffert Jay & Polglaze, P O Box 581009, Minneapolis, MN, 55458-1009, US

(21) Appl. No.: 10/489,944

(22) PCT Filed: Sep. 17, 2002
(86) PCT No.: PCT/IT02/00590

(30) Foreign Application Priority Data
Sep. 18, 2001 (IT) RM2001A000566

(51) Int. Cl. A23L 1/00

(52) U.S. Cl. 99/353

(57) ABSTRACT

Method and apparatus for the superficial conditioning of food extrusion, carrying out the steps of introducing a food extrusion (2) in a conditioning duct (3) for the superficial stabilizing of the extrusion (2); in a first section (4) of said duct (3), spraying the surface of the food extrusion (2) with a stabilizer in form of gel; and in a second section (6) of said duct (3), spraying the surface of the food extrusion (2) with a catalyst of said stabilizer.

The present invention refers to a method and to an apparatus for the superficial conditioning of food extrusions, in particular meat-base extrusions in form of sausages, frankfurters and the like.

There are several known systems for conditioning the surface of said extrusions, in order to manufacture sausage-shaped uncased extrusions, ready to be packaged, e.g. in tubs or in vacuum packages, and then directly consumed.

The methods most widely resorted to foresee the employ of vats containing a bath with collagenic substances. The extrusions, expelled from the machine compacting them in a cylinder-shaped and elongated shape, are passed through said bath and subsequently dried prior to packaging.

This type of systems is unsatisfactory in several respects. In fact, the vats fill up a considerable space, which is detrimental to the compactness of the extrusion apparatus, and are apt to gather environmental pollution, due to the extrusions and to any agent external to the apparatus. This compels the emptying of the vats, and the filling thereof, with the entailed break in the production run and the poor efficiency in the employ of the fluids stabilizing the surface of the food extrusions at issue.

An exemplary process of the state of the art is taught by International Appln. WO 01/41576.

Moreover, it should be pointed out that the animal origin of the collagenic substances might make consumers feel insecure.

The technical problem underlying the present invention is to provide a method and an apparatus overcoming the drawbacks mentioned with reference to the known art.

This problem is solved by a method for the superficial conditioning of food extrusions, characterized in that it comprises the steps of:
introducing a food extrusion in a conditioning duct for the superficial stabilizing of the extrusion;
in a first section of said duct, spraying the surface of the food extrusion with a stabilizer in form of gel; and
in a second section of said duct, spraying the surface of the food extrusion with a catalyst of said stabilizer.

Hereinafter, for stabilizer it is meant a substance capable of forming, onto the surface of the extrusion, a film compatible with food consumption, such as to provide sturdiness and strength to the surface and to the extrusion.

In a preferred embodiment of said method, the stabilizer comprises sodium alginate, carrageen, Xanthan gum, suitably mixed and optionally water-diluted.

Spraying of the catalyst, that in a preferred embodiment of said method comprises calcium lactate, calcium chloride, lactic acid and optionally water-diluted mixtures thereof, accelerates the film-forming reaction. The main advantage of the method according to the present invention lies in conditioning and stabilizing the surface of the extrusion within very limited times and space, to then forward the extrusion to subsequent treatments and to packaging.

The invention further refers to an apparatus for the superficial conditioning of extrusions comprising a closed conditioning duct housing the extrusion, said conditioning duct being partitioned into a first section, fed by first superficial treatment means, and a second section, fed by second superficial treatment means.

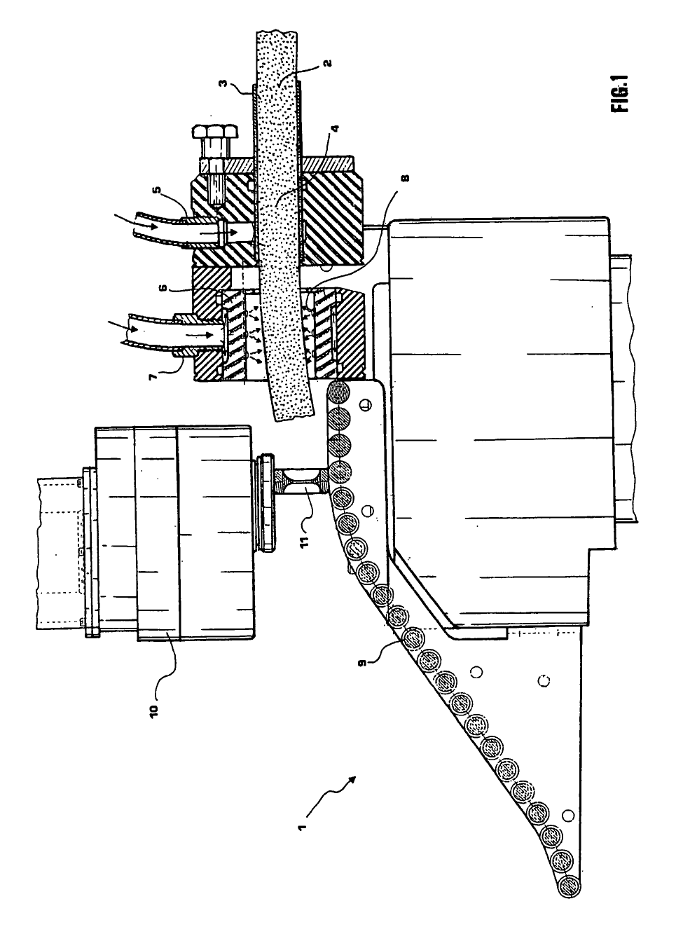

The present invention will hereinafter be disclosed according to a preferred embodiment thereof, given by way of a non-limiting example and with reference to the attached drawing, wherein FIG. 1 is a schematic sectional view of an apparatus for the superficial conditioning of food extrusions according to the present invention, incorporated in a more complex extrusion apparatus.

With reference to FIG. 1, an apparatus for the extruding of food extrusions is partially depicted and indicated with 1.

This type of apparatus is apt to produce extrusions, e.g., meat-base ones, outletted in form of a cylinder-shaped extrusion 2. This apparatus, not providing encasing, should comprise an apparatus for the superficial conditioning of the extrusion, in order to form a superficial stabilizing film onto the surface thereof.

The apparatus for the conditioning, it also partially depicted, comprises a closed conditioning duct 3 housing the extrusion 2 inletted from the extruding and free from any prior stabilization conditioning, merely optionally treated to aromatize the mixture of the extrusion 2.

The conditioning duct is partitioned into a first section 4, fed by first superficial treatment means 5, and a second section 6, fed by second superficial treatment means 6.

The first section 4 consists of a duct portion 3 inside which the extrusion flows, acquiring a section shape similar to the wall thereof.

Inside of this section 4 a stabilizer in form of gel is injected, in order to uniformly cover the surface to be stabilized. The injecting takes place by virtue of said first superficial treatment means 5 feeding said first section 4 with gel at adjustable flow rate and pressure.

A higher pressure and, therefore, a higher flow rate, concur in compacting the extrusion 2 and in thickening the gel layer that, at a subsequent stage, will be turned to film.

The second section 6 consists of a duct portion 3 into which the extrusion 2 flows with a remarkable clearance between the surface to be stabilized and the wall of the duct 3. Said second treatment means 7 comprises, located on said wall at the second section 6, a plurality of nozzles 8 pressure-fed with a catalyst in liquid form.

The geometry of the second section 6 enables the complete spraying of the surface of the extrusion 2.

With reference now to the method for the superficial conditioning, it comprises a step in which the extrusion 2 is introduced in said closed duct 3, in order to insert it in a restricted environment wherein the conditioning that will stabilize the surface of the extrusion 2 is to be carried out.

In said first section 4, the food extrusion 2 is sprayed with a stabilizer provided in form of gel that is capable to form, prior to the subsequent treatment, a sort of unstabilized film onto the surface thereof.

The shape and the thickness of said film are adjusted varying the passage section of the corresponding duct portion 3 and the feed pressure of the gel.

The stabilizer comprises sodium alginate, carrageen, Xanthan gum, optionally mixed and water-diluted. However, it is understood that the stabilizer may comprise equivalent surfactant substances.

However, these substances should be compatible with human consumption of food, i.e., meet the requirements of the standards on the matter. The same principle also applies to any further substance employed onto the surface of the extrusion.

The method comprises the subsequent step, located at the second section 6 of said duct 3, of spraying the surface of the food extrusion 2 with a catalyst of said stabilizer.

In this embodiment, the catalyst, provided in liquid form and sprayed and atomized onto the surface of the extrusion, comprises a mixture of calcium lactate, lactic acid, calcium chloride and optionally water-diluted mixtures thereof. However, it is understood that the catalyst may comprise equivalent surfactant substances.

Going back to the apparatus for the superficial conditioning, downstream of said section 6 it comprises a roller conveyor 9. Located at said conveyor 9 there may be, besides means for portioning the extrusion 10 in form of partitioning members 11, further equipments (not shown) for the subsequent superficial treatment of the extrusion 2.

Among said equipments, the following are mentioned:
an equipment for the superficial rinsing of the extrusion, comprising a rinsing bath, optionally provided with bath agitating means, or with spraying means—the rinsing takes place with water;
an equipment for the compacting of the extrusion with means uninjurious to the newly-conditioned surface of the extrusion, e.g. by ultrasounds; and
an equipment for the superficial drying of the extrusion, operating with one or more forced flows of cold air.

It is understood that the latter two equipments may operate concomitantly.

Said equipments correspond to as many steps of further conditioning, superficial and not superficial, of the extrusion:
a step of rinsing the surface of the extrusion by water immersing or spraying;
a step of compacting the extrusion via the surface thereof, by ultrasound application; and
a step of superficial drying of the extrusion by exposure to one or more cold air flows.

Subsequently to these steps, that usually ensue the portioning of the extrusion, the extrusion portions may be forwarded to further treatments, e.g., smoking, cooking, etc. or to packaging.

To the abovedescribed method and apparatus for the superficial conditioning of food extrusions a person skilled in the art, in order to meet further and contingent needs, may effect several further modifications and variants, all however encompassed by the protective scope of the present invention, as defined by the appended claims.

1-13. (canceled)

14. A method for the superficial conditioning of food extrusions, comprising the steps of:
introducing a food extrusion in a conditioning duct for the superficial stabilizing of the food extrusion;
in a first section of said duct, spraying the surface of the food extrusion with a stabilizer in form of gel; and
in a second section of said duct, spraying the surface of the food extrusion with a catalyst of said stabilizer.

15. The method according to claim 14, wherein said stabilizer comprises at least one of the following substances: sodium alginate, carrageen, and Xanthan gum, and, optionally, water-diluted mixtures thereof.

16. The method according to claim 14, wherein said catalyst comprises at least one of the following substances: calcium lactate, calcium chloride, and lactic acid, and, optionally, water-diluted mixtures thereof.

17. The method according to claim 14, comprising a step of rinsing the surface of the extrusion by water immersing or spraying.

18. The method according to claim 14, comprising a step of compacting the extrusion via the surface thereof, by ultrasound application.

19. The method according to claim 14, comprising a step of superficial drying of the extrusion by exposure to one or more cold airflows.

20. An apparatus for the superficial conditioning of extrusions comprising a closed conditioning duct housing the food extrusion, said closed conditioning duct being partitioned into a first section, comprising first superficial treatment means, and a second section, comprising second superficial treatment means.

21. The apparatus according to claim 20, wherein the first section consists of a closed duct portion inside which the food extrusion flows with a minimum clearance between the surface to be stabilized and the wall of the closed duct.

22. The apparatus according to claim 21, wherein inside of the first section a stabilizer in form of gel is injected, in order to uniformly cover the surface to be stabilized, the injecting taking place by virtue of said first superficial treatment means feeding said first section gel at adjustable flow rate and pressure.

23. The apparatus according to claim 20, wherein the second section consists of a closed duct portion inside which the food extrusion flows with a remarkable clearance between the surface to be stabilized and the wall of the closed duct, said second treatment means comprises a plurality of nozzles located on said wall at the second section and pressure-fed with a catalyst in liquid form.

24. The apparatus according to claim 20, comprising an equipment for the superficial rinsing of the extrusion, comprising a rinsing bath, optionally provided with bath agitating means, or with spraying means.

25. The apparatus according to claim 20, comprising an equipment for the compacting of the extrusion with means uninjurious to the surface of the newly conditioned extrusion, e.g. by ultrasounds.

26. The apparatus according to claim 21, comprising an equipment for the superficial drying of the extrusion, operating with one or more forced flows of cold air.
